(19) United States
(12) Patent Application Publication
(10) Pub. No.: US 2010/0065998 A1
(43) Pub. Date: Mar. 18, 2010

(54) Arrangement for retaining a compliance bush assembly

(75) Inventors: Shoichi Tomida, Wako (JP); Tetsushi Yamada, Wako (JP); Takaki Ohdo, Wako (JP)

Correspondence Address: CARRIER BLACKMAN AND ASSOCIATES, 43440 WEST TEN MILE ROAD, EATON CENTER, NOVI, MI, 48375, US

(73) Assignee: Honda Motor Co., Ltd., Tokyo (JP)

(21) Appl. No.: 12/283,990

(22) Filed: Sep. 17, 2008

(51) Int. Cl. B60G 11/22

(52) U.S. Cl. 267/293

(57) ABSTRACT

In an arrangement for retaining an outer collar (13) of a compliance bush assembly, an internal bore of a corresponding retaining collar (9) which may be welded to a front end of a trailing arm (2, 3) is provided with an increased diameter portion (20) defining an annular step (21) adjacent to a leading axial end thereof at the time of the press fitting process. When the outer collar is press fitted into the internal bore of the retaining collar, the part of the outer collar facing the increased diameter portion is allowed to bulge out as a result of creep deformation. Thus, even when the outer collar undergoes a creep deformation, and this causes the pressure acting between the outer collar and retaining collar to diminish, the part of the outer collar facing the increased diameter section that has bulged out prevents the outer collar from shifting or dislodging from the retaining collar.

### TECHNICAL FIELD

The present invention relates to an arrangement for retaining a compliance bush assembly for a wheel suspension system, and in particular to an arrangement for retaining a compliance bush assembly using an outer collar made of plastic material.

### BACKGROUND OF THE INVENTION

The twist beam wheel suspension system or torsion beam wheel suspension system is one of the most preferred types of wheel suspension systems for small passenger vehicles. A torsion beam wheel suspension system typically comprises a pair of trailing arms and a cross member known as a torsion beam connecting intermediate points of the trailing arms. This wheel suspension system can provide a favorable ride quality of an independent wheel suspension system and a suitable roll rigidity at the same time while the structure is highly simple.

The front end of each trailing arm is pivotally connected to the vehicle body via a compliance bush that includes an inner collar and an outer collar that are coaxially disposed to each other and connected by a rubber bush to isolate the vehicle body from the vibrations from the road surface. The inner collar is fitted onto a pin fixedly attached to the vehicle body via a bracket, and the outer collar is press fitted into a retaining collar fixedly secured to the front end of the trailing arm.

The outer collar may be made of plastic material for the purpose of reducing the weight of the assembly and reducing the manufacturing cost. However, plastic material is known to undergo creep deformation over time when it is subjected to temperature fluctuations as opposed to a metallic component part. Therefore, it is sometimes required to take a suitable measure to ensure that the outer collar does not shift in position relative to a retaining tube of a trailing arm into which the outer collar is press fitted. The outer collar may be reinforce by using a metallic ring insert molded in a flange part of the outer collar as proposed in Japanese patent laid open publication No. 2004-138212. The outer collar may be provided with a radial flange at one end and an engagement claw at the other end that engages an axial end of the retaining collar as proposed in Japanese patent laid open publication No. 2007-177820.

However, the first proposal has the disadvantage of increasing the number of component parts and manufacturing steps. The second proposal has the disadvantage of increasing the overall length of the outer collar, and this may cause a problem when the available space is limited. Also, a greater force is required for press fitting the outer collar into the retaining collar, and this complicates the management of the manufacturing process.

### BRIEF SUMMARY OF THE INVENTION

In view of such problems of the prior art, a primary object of the present invention is to provide a compliance bush which is economical to manufacture but reliable in use.

A second object of the present invention is to provide a compliance bush which is easy to assemble but reliable in use.

According to the present invention, such objects can be accomplished by providing an arrangement for retaining an outer collar of a compliance bush assembly, comprising: an inner collar configured to be pivotally supported by a first member; an elastomeric bush member fixedly attached to an inner circumferential surface of the inner collar; an outer collar disposed coaxillay with respect to the inner collar and fixedly attached to the outer surface of the elastomeric bush member, the outer collar being provided with a first axial end and a second axial end; and a retaining collar fixedly attached to a second member and defining an internal bore which is configured to receive the outer collar in a tight fit; wherein the internal bore of the retaining collar is provided with a increased diameter section that defines an annular step in cooperation with a remaining part of the internal bore, and the annular step overlaps with the first axial end of the outer collar.

Thus, even when the outer collar undergoes a creep deformation over time, and this causes the pressure acting between the outer collar and retaining collar to diminish, the part of the outer collar facing the increased diameter section and adjacent to a leading axial end thereof at the time of the press fitting process bulges out, and the bulging part prevents the outer collar from shifting or dislodging from the retaining collar.

In a preferred embodiment of the present invention, the outer collar is formed with a radial external flange at the second axial end thereof, and the radial external flange abuts a corresponding axial end of the retaining collar. The radial flange determines how deep the outer collar may be inserted in the retaining collar, and once the outer collar is fully press fitted into the retaining collar, the annular step of the internal bore of the retaining collar ensures that the outer collar is not pulled out of the internal bore of the retaining collar.

Typically, the first member is fixedly attached to a vehicle body, and the second member is fixedly attached to a front end of a trailing arm. Preferably, the retaining collar is made of steel, and the outer collar is made of plastic material. According to a certain aspect of the present invention, the first axial end of the outer collar is formed with a chamfered or beveled corner around an outer circumference thereof, and the internal bore of the retaining collar is provided with a chamfered or beveled corner at an axial end corresponding to the second axial end of the outer collar.

### BRIEF DESCRIPTION OF THE DRAWINGS

Now the present invention is described in the following with reference to the appended drawings, in which:

FIG. 1 is a perspective view of a torsion beam rear wheel suspension system embodying the present invention;

FIG. 2 is a fragmentary perspective view of a front end of a trailing arm connected to the vehicle body via a compliance bush assembly surrounded by circle II in FIG. 1;

FIG. 3 is a plan view partly in section showing the compliance bush assembly according to the present invention;

FIG. 4 is an enlarged longitudinal sectional view taken along line IV-IV of FIG. 3;

FIG. 5 is an exploded longitudinal section view illustrating the process of press fitting the outer collar of the compliance bush assembly into the internal bore of the retaining collar of the trailing arm; and

FIG. 6 is a graph comprising the force required to pull out the outer collar from the retaining collar under various conditions.

### DETAILED DESCRIPTION OF THE PREFERRED EMBODIMENTS

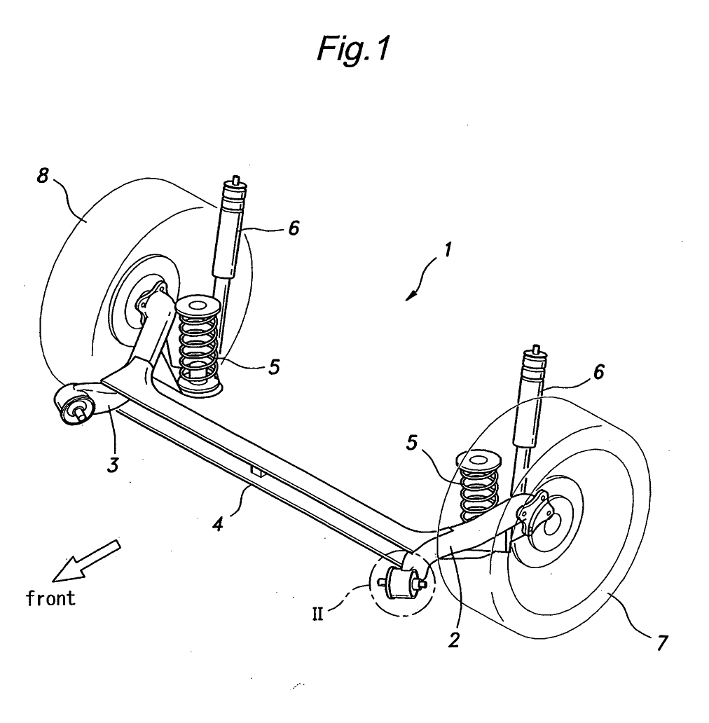

FIG. 1 shows a rear wheel suspension system of an automobile embodying the present invention. This rear wheel suspension system 1 consists of a H-type torsion beam wheel suspension system which comprises a pair of trailing arms 2 and 3 each having a base end pivotally attached to the vehicle body for a vertical swinging movement and carrying a rear wheel 7, 8 at a rear end thereof, a torsion beam 4 extending laterally across the vehicle body and connecting intermediate points of the trailing arms 2 and 3 to each other, a pair of coil springs 5 resiliently supporting the corresponding trailing arms 2 and 3 to the vehicle body and a pair of shock absorbers each provided between the corresponding trailing arm and the vehicle body adjacent to the corresponding coil spring 5 for controlling the oscillating movement of the vehicle body.

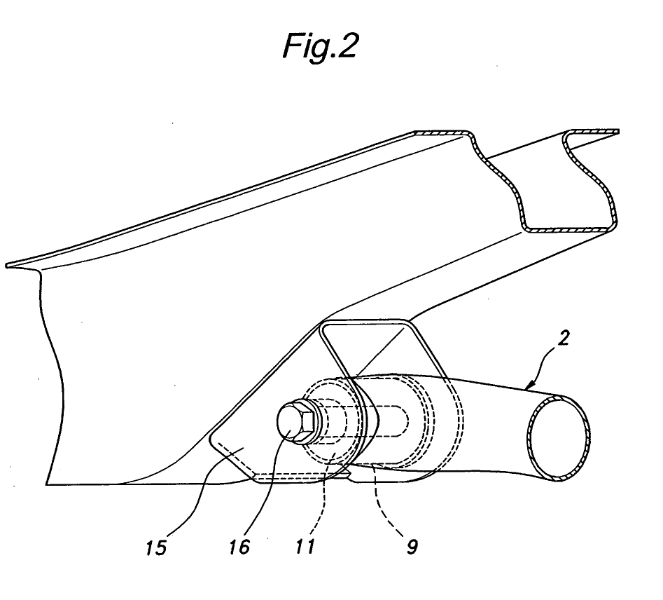

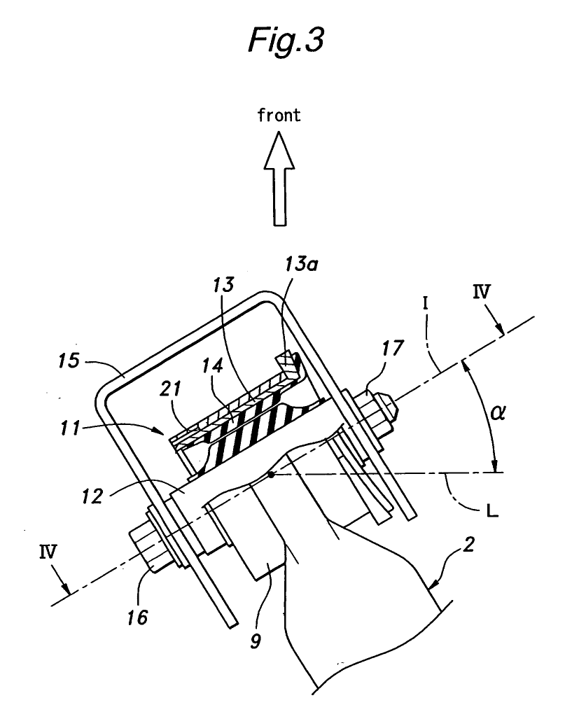

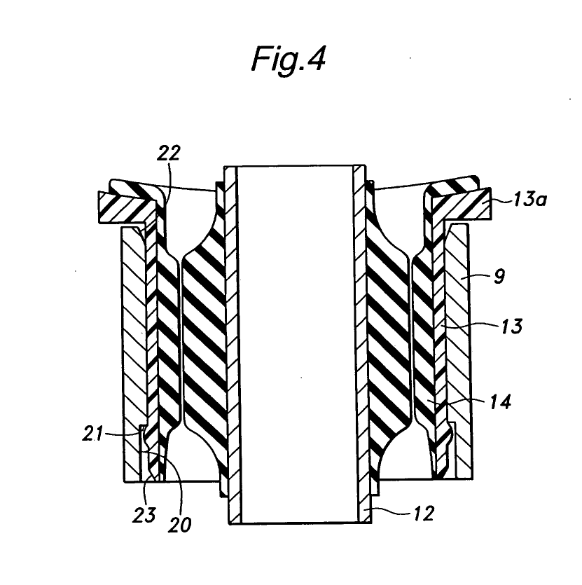

Referring to FIGS. 2 to 4, a bracket 15 is fixedly attached to a part of the vehicle body corresponding to the front end of each trailing arm 2, and comprises a pair of upright walls extending parallel to each other and separated from each other by a prescribed distance. A threaded bolt 16 is passed across the upright walls, and is received in a tubular inner collar 12 in a section of the threaded bolt 16 located between the upright walls. The inner collar 12 is made of steel in the illustrated embodiment. The length of the inner collar 12 is substantially identical to the spacing between the upright walls, and the free end of the threaded bolt 16 which extends out of the corresponding upright wall is threaded into a nut 17. The inner collar 12 is fixedly surrounded by an elastomeric bush member 14, and the elastomeric bush member 14 is fixedly surrounded by an outer collar 13 made of plastic material. To the front end of the corresponding trailing arm 2 is welded a retaining collar 9 consisting of a tubular member made of steel and defining an internal bore having an axial line I extending at an angle α with respect to the lateral direction indicated by line L in FIG. 3. The outer collar 13 is provided with a radial external flange 13a at an axial end thereof, and the retaining collar 9 abuts the flange 13a that overhangs the axial end of the corresponding axial end of the retaining collar 9.

The compliance bush assembly 11 including the tubular collar 12 made of steel, elastomeric bush 14 and outer collar made of plastic material is press fitted into the retaining collar 9 of the trailing arm 2. When the outer collar 13 is fully fitted into the retaining collar 9, the corresponding axial end of the retaining collar 9 abuts the external radial flange 13a, which hangs over the corresponding axial end of the retaining collar 13a. The elastomeric bush member 14 is cured after it is filled in an annular gap defined between the inner collar 12 and outer collar 13 which are arranged in a coaxial relationship, and partly covers the outer axial end surface of the radial flange 13a of the outer collar 13. The elastomeric bush member 14 may be suitably shaped and provided with axial recesses and/or through holes so as to provide a desired compliance in a desired direction.

The axial end of the internal bore of the retaining collar 9 adjacent to the radial flange 13a of the outer collar 13 is formed with a chamfered or beveled portion 22 that facilitates the press fitting of the outer collar 13 into the internal bore of the retaining collar 9. The end of the outer collar 13 remote from the radial flange 13a thereof is formed with a similar chamfered or beveled portion 23 on an outer periphery thereof for the same purpose. The other axial end of the internal bore of the retaining collar 9 remote from the radial flange 13a of the outer collar 13 is formed with a large diameter section 20 that defines an annular step 21 at a part thereof adjoining the remaining part of the internal bore. In the illustrated embodiment, a relatively sharp 90 angle corner is defined between the main part of the internal bore and annular step 21 as seen in the longitudinal sectional view.

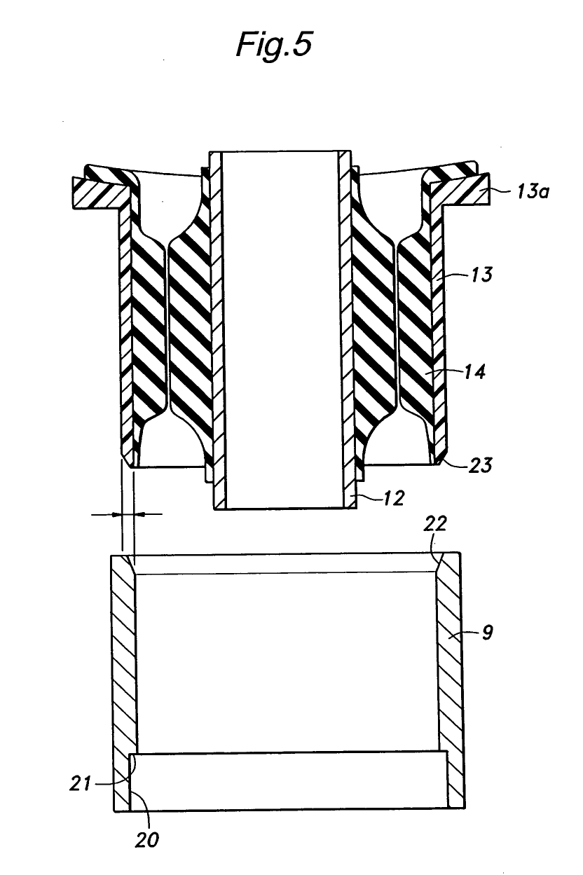

Referring to FIG. 5, when press fitting the outer collar 13 of the compliance bush assembly 11 into the internal bore of the retaining collar 9, the axial end of the outer collar 9 remote from the flange 13a provided with the beveled portion 23 is initially fitted into the axial end of the internal bore of the retaining collar 9 provided with the beveled portion 22. Then, the outer collar 13 is pushed further into the internal bore until and radial flange 13a abuts the axial end of the retaining collar 9 and the free end of the outer collar 13 extends a small distance beyond the annular step 21.

The radial pressure acting between the retaining collar 9 and outer collar 13 provides an adequate friction between the retaining collar 9 and outer collar 13 that keeps the two parts in a relatively fixed position. Over time, the outer collar 13 may undergo a creep deformation, and this may reduce the radial pressure between the two parts. However, the creep deformation also causes a part of the material of the outer collar 13 to flow to the free end of the outer collar 13 extending beyond the annular step 21 so that the part of the outer surface of the outer collar 13 facing the increased diameter portion 20 of the internal bore and adjacent to the annular step 21 forms a localized increased diameter portion which engages the annular step 21 against the axial movement of the retaining collar 9 relative to the outer collar 13. Therefore, the outer collar can be firmly retained to the retaining collar at all times.

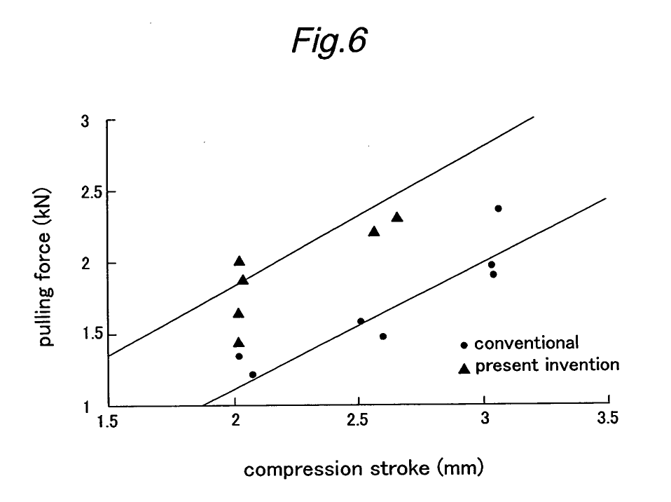

FIG. 6 is a graph comparing the forces that are required to pull out the outer collar 13 from the retaining collar 9 after a prescribed aging period. The abscissa shows the difference in the outer diameter of the outer collar 13 and inner diameter of the retaining collar 9 or the compression stroke of the outer collar 13 caused by the press fitting process. The greater this difference is, the firmer the press fitting is. However, if this difference is excessive, the outer collar 13 may be damaged in the press fitting process. Without regard to the magnitude of this difference, the present invention consistently required a greater force for pulling the outer collar 13 from the retaining collar 9 than the conventional arrangement which is essentially identical to the present invention except for the absence of the increased diameter portion 20 of the internal bore of the retaining collar 9.

Although the present invention has been described in terms of a preferred embodiment thereof, it is obvious to a person skilled in the art that various alterations and modifications are possible without departing from the scope of the present invention which is set forth in the appended claims. For instance, the compliance bush assembly of the present invention can also be used in other types of wheel suspension systems, and other parts of wheel suspension systems.

The contents of the original Japanese patent application on which the Paris Convention priority claim is made for the present application and the contents of any related prior art mentioned in the disclosure are incorporated in this application by reference.

1. An arrangement for retaining an outer collar of a compliance bush assembly, comprising:
an inner collar configured to be pivotally supported by a first member;
an elastomeric bush member fixedly attached to an inner circumferential surface of the inner collar;
an outer collar disposed coaxillay with respect to the inner collar and fixedly attached to the outer surface of the elastomeric bush member, the outer collar being provided with a first axial end and a second axial end; and
a retaining collar fixedly attached to a second member and defining an internal bore which is configured to receive the outer collar in a tight fit;
wherein the internal bore of the retaining collar is provided with a increased diameter section that defines an annular step in cooperation with a remaining part of the internal bore, and the annular step overlaps with the first axial end of the outer collar.

2. The arrangement for retaining an outer collar of a compliance bush assembly according to claim 1, wherein the outer collar is formed with a radial external flange at the second axial end thereof, and the radial external flange abuts a corresponding axial end of the retaining collar.

3. The arrangement for retaining an outer collar of a compliance bush assembly according to claim 1, wherein the first member is fixedly attached to a vehicle body, and the second member is fixedly attached to a front end of a trailing arm.

4. The arrangement for retaining an outer collar of a compliance bush assembly according to claim 1, wherein the retaining collar is made of steel, and the outer collar is made of plastic material.

5. The arrangement for retaining an outer collar of a compliance bush assembly according to claim 1, wherein the first axial end of the outer collar is formed with a chamfered or beveled corner around an outer circumference thereof.

6. The arrangement for retaining an outer collar of a compliance bush assembly according to claim 1, wherein the internal bore of the retaining collar is provided with a chamfered or beveled corner at an axial end corresponding to the second axial end of the outer collar.
